(19) United States
(12) Patent Application Publication
(10) Pub. No.: US 2006/0032233 A1
(43) Pub. Date: Feb. 16, 2006

(54) Inlet film cooling of turbine end wall of a gas turbine engine

(76) Inventors: Luzeng John Zhang, San Diego, CA (US); Hee Koo Moon, San Diego, CA (US)

Correspondence Address: Michael B. McNeil;Liell & McNeil Attorneys PC, P.O. Box 2417, Bloomington, IN, 47402, US

(21) Appl. No.: 10/915,658

(22) Filed: Aug. 10, 2004

(51) Int. Cl. F02C 6/08

(52) U.S. Cl. 60/782

(57) ABSTRACT

The disclosure provides a gas turbine engine having a plurality of nozzle vanes extending between an inner shroud wall and an outer shroud wall of the engine. Each of the vanes includes a leading edge and at least one cooling protrusion extending upstream from a center of the leading edge. A cooling system is provided that is operable to inject cooling air upstream from the vanes. The disclosure also provides a method of cooling a gas turbine engine. The method includes the steps of supplying cooling air to an engine nozzle upstream of a gas directing vane, and adjusting the flow of the cooling air with a cooling protrusion extending forward from a leading edge center of the vane.

### TECHNICAL FIELD

The present disclosure relates generally to gas turbine engines, and relates more particularly to such an engine having improved inlet film cooling.

### BACKGROUND

Gas turbine engines are well known and widely used power sources. In common land based applications, a gas turbine engine may be used to drive an electrical generator, converting fossil fuel energy into electricity for powering a virtually unlimited variety of devices. Many airplanes and helicopters also employ gas turbine engines to drive props or rotors. Such engines typically employ a rotating shaft with a plurality of turbine blades at one end, and an air compressor at the other end. The shaft is rotated by combustion gases acting on the turbine blades; rotation of the shaft in turn powers the air compressor and supplies the compressed air necessary for combustion.

A typical gas turbine engine includes an inner shroud and an outer shroud connected at a nozzle with a combustor. The combustor in turn is connected to a source of fuel and a source of compressed air. The compressed air and fuel are simultaneously delivered to a combustion chamber in the combustor, and autoignite therein. Thus, once the gas turbine engine is started, the fuel and air will continuously combust, driving the turbines, which in turn drive the compressor via the shaft. The shrouds provide a generally doughnut shaped passage through which combustion gases pass, driving one or more turbine stages and typically passing one or more vane stages which direct the combustion gases through the shrouds.

Such engines represent a relatively high power density source, converting a higher proportion of fuel energy into electrical or mechanical energy than many other types of combustion engines for a given physical sizes. When fuel and relatively highly compressed air are ignited, however, the mixture can burn at a relatively high temperature, in some cases close to or above the temperature the engine components can withstand. Thus, gaseous combustion products exiting the combustor can actually melt or burn engine components they contact. Operating efficiency of a gas turbine engine generally increases with a higher burn temperature and, accordingly, it is often desirable to burn the fuel and air at as high a temperature as possible.

In an attempt to optimize efficiency, engineers have developed many engine designs, materials and operating schemes to allow gas turbine engines to operate at ever higher temperatures. The use of exotic materials and coatings for various engine components exposed to extreme temperatures is one means of protecting the engine, however, such materials tend to be cost ineffective for production models. Other, relatively elaborate cooling schemes have developed, for example, backside cooling of the engine shrouds with a suitable heat transfer fluid. Such designs, however, require numerous sophisticated components and again, tend to be relatively expensive to put into practice.

One relatively effective cooling method is known in the art as “inlet film cooling” or by similar terms. In inlet film cooling, a thin film of air is injected along surfaces exposed to high temperature gases from the combustor. The air is continuously injected at relatively high pressures, providing an insulative layer of relatively cool air that flows between the engine surfaces and the hot combustion gases. Thus, the stream of hot combustion gases may be thought of as being cushioned by a layer of cooler air as the combustion gases travel between walls of the shrouds.

Inlet film cooling has received increased attention in recent years, however, it too has its limitations as presently practiced. The cooling air generally serves its intended function so long as the air in the thin film layer can flow along a relatively unobstructed surface. When an obstruction is encountered, however, the thin film layer can mix with, or be displaced by the hot combustion gases. Mixing and/or displacement can occur, for example, where the thin film layer and combustion gases impinge upon a gas directing vane. Rather than continuing a relatively smooth flow, maintaining sufficient separation of the layers, vortices can form proximate the obstruction. Disruption of the thin film can ultimately allow the hot combustion gases to compromise the integrity of internal engine components. This problem is particularly acute in nozzle end wall regions close to the combustor exit where the combustion gases are hottest.

Engineers have attempted to enhance the effectiveness of inlet film cooling by increasing the relative quantity of compressor air output that is siphoned off to cool the engine end walls. Injecting a relatively greater quantity of air can offset the described disruption in the thin film layer. Increasing the amount of cooling air, however, can reduce the quantity of the air that can be supplied for combustor operation and cooling, or reduce attainable turbine inlet temperatures. As a result, designers have reached a point of diminishing returns in providing increased turbine output power, with adequate cooling of the combustor.

The present disclosure is directed to one or more of the problems or shortcomings set forth above.

### SUMMARY OF THE DISCLOSURE

In one aspect, the present disclosure provides a gas turbine engine having a plurality of nozzle vanes extending between an inner shroud wall and an outer shroud wall of the engine. Each of the vanes includes a leading edge and at least one cooling protrusion extending upstream from a center of the leading edge. A cooling system is provided that is operable to inject cooling air upstream from the vanes.

In another aspect, the present disclosure provides a gas turbine engine nozzle section. The section includes a first shroud portion having an end wall, and a second shroud portion. At least one vane is connected between the first and second shroud portions, and includes an airfoil portion and a cooling protrusion disposed adjacent the end wall.

In yet another aspect, the present disclosure provides a method of cooling a gas turbine engine. The method includes the steps of supplying cooling air to an engine nozzle upstream of a gas directing vane, and adjusting the flow of the cooling air with a cooling protrusion extending forward from a leading edge center of the vane.

### BRIEF DESCRIPTION OF THE DRAWINGS

FIG. 1 is a partial side view of a gas turbine engine according to the present disclosure;

FIG. 2 is a perspective view of a gas turbine engine nozzle section according to the present disclosure;

FIG. 3 is a partially sectioned vane suitable for use in the gas turbine engine of FIG. 1;

FIG. 4 is a partial perspective view of a gas turbine engine nozzle section according to the present disclosure.

### DETAILED DESCRIPTION

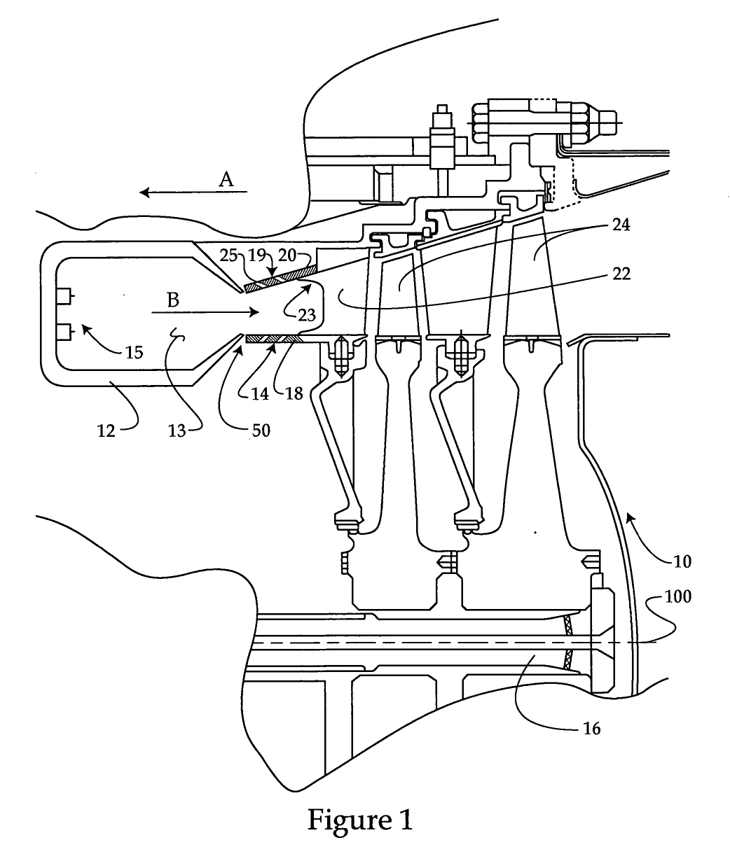

Referring to FIG. 1, there is shown a partial view of a gas turbine engine 10 according to a preferred embodiment of the present disclosure. Engine 10 is preferably a land-based gas turbine engine, for example of the type used to drive an electrical generator, and includes a combustor 12 connected to a compressed air supply (not shown) and a fuel supply (not shown) in a conventional manner. Combustor 12 preferably includes a doughnut-shaped combustion chamber 13 having inlets 15 for air and fuel. During operation, air and fuel are injected into combustor 12 and ignite in chamber 13, providing a supply of hot, expanding combustion products that exit chamber 13 in a “downstream” direction, shown generally with arrow “B”, to a nozzle section 50. An “upstream” direction is illustrated generally with arrow “A”. Nozzle section 50 preferably includes a portion of an inner shroud 18 and an outer shroud 20. In a preferred embodiment, shrouds 18 and 20 extend about the exit from chamber 13 in a shape generally complementary to the doughnut shape of combustor 12, thus providing a generally cylindrical pathway for gases exiting the same.

A first endwall portion 14 is positioned adjacent, or formed integrally with inner shroud 18, whereas a second endwall portion 19 is adjacent or integral with outer shroud 20. A plurality of coolant gas inlet holes 25 are preferably defined by endwalls 14 and 19 and are preferably fluidly connected to the compressed air supply, as described herein. Those skilled in the art will appreciate that although end wall portions 14 and 19 are shown as integral pieces with inner shroud 14 and outer shroud 19, the nozzle “endwalls” of engine 10 may be thought of as the portions of the shroud extending generally between holes 25 and past vane 22 to the next engine section, irrespective of whether single or multiple stages are used.

Gases exiting combustor 12 pass downstream through a portion of nozzle section 50 and encounter a plurality of gas directing vanes, illustrated with one such vane 22 in FIG. 1. In a preferred embodiment, the vanes are positioned radially symmetrically about nozzle section 50, and direct the combustor output helically between inner shroud 18 and outer shroud 20. It should be understood that the description of individual vane 22 herein is intended to refer to any of the vanes positioned between shrouds 18 and 20, as the respective vanes are preferably identical. In a preferred embodiment, vane 22 provides an airfoil, allowing gases directed there past to flow relatively smoothly. At least one cooling protrusion 23, preferably two, is included on vane 22 and projects generally upstream toward combustor 12 along end walls 14 and 19.

Combustion gases passing the vanes subsequently encounter a plurality of turbine blades 24, rotatable about an axis 100 of engine 10 and coupled to a shaft 16 extending within inner shroud 18. Shaft 16 is preferably coupled to a plurality of sets of turbine blades 24, each of the sets being separated by a set of fixed vanes directing gases in a helical fashion between the turbine blade sets in a conventional manner. Shaft 16 is further preferably coupled to an air compressor (not shown) operable to supply compressed air to combustor 12, coolant holes 25 and also coupled to a load such as an electrical generator.

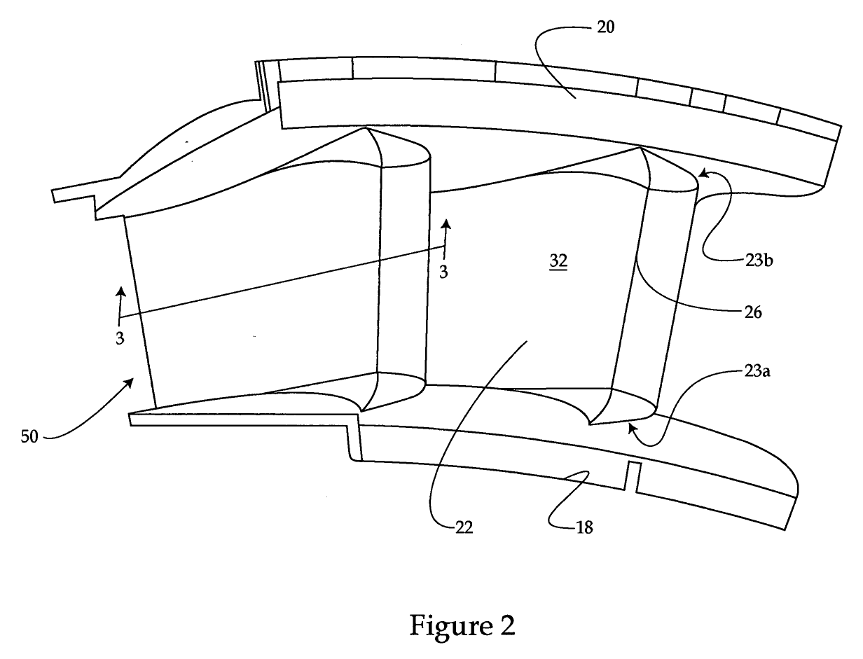

Turning to FIG. 2, there is shown in perspective a nozzle section 50 similar to nozzle section 50 described with regard to FIG. 1. Nozzle section 50 preferably includes a plurality of vanes 22, an inner shroud portion 18 and an outer shroud portion 20. In a preferred embodiment, nozzle section 50 is a portion of a complete nozzle that can be positioned downstream from a gas turbine engine combustor such as combustor 12 of FIG. 1. Thus, each of inner and outer shroud portions 18 and 20 are preferably arcuate. A plurality of nozzle sections identical or similar to section 50 may be adjoined to form a doughnut-shaped, complete nozzle. It is contemplated that nozzle section 50 will preferably be cast as a unitary piece, however, embodiments are contemplated having a plurality of attachable pieces.

Each vane 22 preferably includes an airfoil portion 27 having a pressure or concave side 32 and a suction or convex side (not visible in FIG. 2). The respective concave side 32 and convex side meet at a leading edge 26 of the vane 22. Leading edge 26 is preferably the generally upstream edge of an airfoil portion 27 that is initially impinged upon by combustion gases travelling downstream from combustor 12. Combustion gases meeting leading edge 26 pass either to one side of leading edge 26 along concave side 32, or to the other side of leading edge 26 along the convex side.

A first and a second cooling protrusion 23a and 23b, respectively, preferably substantially mirror images of one another, extend in a generally upstream direction from airfoil portion 27, and are preferably positioned adjacent inner shroud 18 and outer shroud 20. Although each vane 22 is preferably equipped with two cooling protrusions, embodiments are contemplated wherein only a single such protrusion is used for one of shrouds 18 and 20, if necessary some other cooling method such as backside cooling is used for the other of the shrouds.

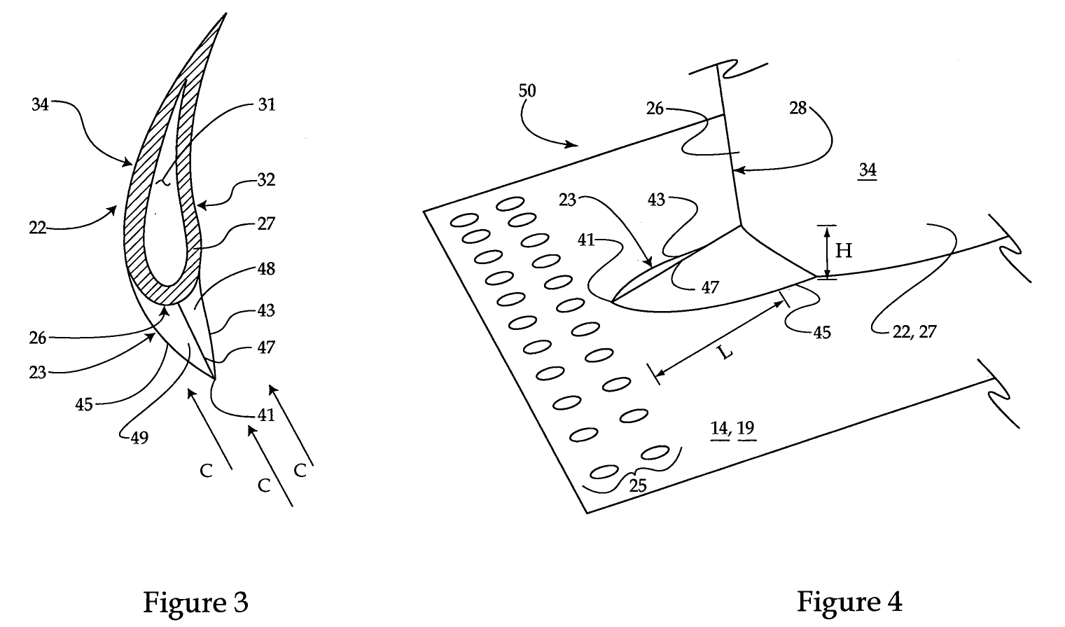

Referring also to FIG. 3, there is shown a partially sectioned view of a vane 22, taken along line 3-3 of FIG. 2. Vane 22 preferably includes a hollow interior 31 to facilitate cooling thereof, for example, with a suitable cooling fluid pumped there through in a manner known in the art. FIG. 3 further illustrates concave side 32 and convex side 34 of vane 22, leading edge 26 and airfoil portion 27. Arrows “C” represent an approximate direction of downstream combustion gas flow toward vane 22.

The included cooling protrusion 23 is shown in FIG. 3 in elevation, and includes a flow splitting feature that preferably comprises a first surface 48 and a second surface 49. Surfaces 48 and 49 extend downstream from a nose 41 toward leading edge 26. First and second surfaces 48 and 49 are preferably planar and symmetrical at least between nose 41 and leading edge 26. A common edge 47 preferably separates first and second surfaces 48 and 49, and is most preferably oriented in alignment with the incident gas flow shown with arrows C. Those skilled in the art will appreciate that the flow splitting feature might include continuous, or smoothly curving surfaces rather than planar surfaces and relatively sharp angles/edges, as shown.

Cooling protrusion 23 further includes a first outboard edge 43 along first surface 48 that preferably extends downstream from nose 41 and transitions to concave side 32 at a point slightly downstream from leading edge 26. Similarly, cooling protrusion 23 includes a second outboard edge 45 along second surface 49 that extends downstream from nose 41 and transitions to concave side 34 at a point slightly downstream from leading edge 26. Second outboard edge 45 is preferably longer than first outboard edge 43, and thus second surface 49 includes a greater surface area than first surface 48. The relative lengths of edges 43 and 45, and the respective areas of surfaces 48 and 49 may be varied depending upon such factors as the orientation of vane 22 relative to airflow C, or the “angle of attack.”

FIG. 4 illustrates a portion of nozzle section 50 including vane 22 positioned adjacent an endwall, which could be either of endwalls 14 or 19. Cooling air inlet holes 25 are shown positioned upstream from vane 22, and cooling protrusion 23. In a preferred embodiment, holes 25 are oriented at substantially 30° relative to a surface of end wall 14, 19 such that cooling air is injected at approximately the same angle. Alternative embodiments may be better suited to lesser or greater angles of cooling air injection.

In designing a suitable cooling protrusion, the vertical distance between the shrouds may be used as a general guide for determining the appropriate relative sizes of the cooling protrusion features. Cooling protrusion 23 preferably extends an upstream distance from a leading edge center 28 that is approximately 1/10^{th} of a vertical distance between shrouds 18 and 20. Thus, a length “L” shown in FIG. 4 represents the distance upstream, as measured generally parallel end wall 14, 19 that nose 41 is displaced from leading edge center 28. A height “H′” is also shown in FIG. 4, and represents a “height” of cooling protrusion 23 as measured between shrouds 18 and 20, H′ being preferably about 1/20^{th} of the vertical distance between the shroud walls. It is preferred to size cooling protrusion 23 such that it does not extend substantially above the thin film cooling air layer travelling along end wall 14, 19. In a preferred embodiment, first and second outboard edges 43 and 45 are between about six and about eight times height H′. Most preferably, first outboard edge 43 is between about 31% and 32% of the vertical distance between the shrouds, whereas second outboard edge 45 is between about 37% and 38% said vertical distance. It should be understood that the foregoing relative dimensions are exemplary only, and should not be construed to limit the scope of the appended claims. Various factors such as engine operating temperature, combustor output, cooling air pressure and injection angle, etc. may all influence the design considerations for cooling protrusion 23.

### INDUSTRIAL APPLICABILITY

Returning to FIG. 1, when ignition of engine 10 is desired, fuel and pressurized air are supplied to combustion chamber 13, autoigniting therein. The gaseous combustion products travel downstream from combustor 12, substantially in a direction aligned with arrow B, and enter the nozzle, illustrated with nozzle portion 50 in FIG. 1. Pressurized air from the engine air compressor is delivered to end walls 14 and 19 and passes through holes 25, ejecting out of end walls 14 and 19, preferably at approximately 30° relative thereto. In a preferred embodiment, less than about 3% of the compressor output is delivered via holes 25, and most preferably less than about 2%.

The gaseous combustion products passing through nozzle section 50 are relatively hot, and may have a tendency to damage end walls 14 and 19 without a means for cooling and/or protecting the same. Compressed air from holes 25 preferably provides a “thin film” of fluid travelling between the hot combustion gases and end walls 14 and 19. The thin film provides a fluid boundary layer that preferably substantially surrounds the stream of hot combustion gases, and allows the same to pass through the nozzle without imparting an undue amount of heat energy to end walls 14 and 19 and the associated shrouds 18 and 20, respectively.

Thus, the combustion gases will travel through the nozzle, substantially isolated from the surrounding engine components by the thin film until the gases reach the vanes, such as vane 22. Combustion gases reaching vane 22 will be directed in accordance with the curvature thereof, in effect helically reorienting the combustion gases prior to delivering the same to the first turbine stage 24. As the respective thin film and combustion gases approach vane 22, the thin film layer initially encounters nose 41 of cooling protrusion 23, and is subsequently directed substantially into two paths, each path corresponding to one of first and second surfaces 48 and 49. The cooling air traveling in the thin film can relatively smoothly split about cooling protrusion 23, and thenceforth transition to portions of end wall 14, 19 downstream from leading edge 26 of vane 23, as well as along concave side 32 and convex side 34 of vane 22. Providing a flow splitting feature including surfaces 48 and 49 allows the thin film to remain predominantly in a flow pattern that follows the end walls, thereby reducing the tendency for hot combustion gases to heat the end walls and damage the engine or limit its performance.

Combustion gases and the thin film layer impinging upon the leading edge of a conventional vane (not shown) will have a tendency to mix, as the flow of the fluid striking the leading edge will tend to be disrupted. Vortices are believed to form in the region of a vane leading edge, and to a certain extent downstream thereof that mix the thin film and hot combustion gases. Under such circumstances in a conventional engine, the hot combustion gases may come directly into contact with the end walls, heating the same to an unacceptable degree. By equipping the vanes with cooling protrusions, such as those disclosed herein, the tendency for vortices and other disruptive flow to develop is reduced, allowing a relatively smaller amount of compressor air output to perform a desired thin film cooling function than formerly required.

After the combustion gases and thin film of cooling air pass the first stage vanes the gases are directed into first turbines 24, oriented at an angle relative to the gas flow such that the gas causes the turbines to rotate and spin shaft 16 in a manner well known in the art. After passing through turbines 24, the gases are preferably again directed through a set of gas directing vanes in preparation for the next turbine stage. Work performed by the combustion gases on blades 24 and shaft 16 represents energy extracted from the gases, and the pressure and temperature of the same will be lowered. Accordingly, after passing through turbines 24, overheating concerns relating to the end walls are reduced. The presently described apparatus and method is therefore most applicable to the nozzle region 50 of engine 10 in the vicinity of the first vane stage. However, other applications are contemplated wherein two or more of the vane stages of engine 10 are provided with one or more cooling protrusions 23 as described herein.

The present description is for illustrative purposes only, and should not be construed to narrow the scope of the present disclosure. Those skilled in the art will appreciate that various modifications might be made to the presently disclosed embodiments without departing from the intended spirit and scope thereof. For instance, the presently disclosed embodiments might be used in combination with other cooling schemes, such as advanced materials, heat resistant coatings, or backside cooling of the shrouds. The relative dimensions, positioning or use of the cooling protrusions disclosed herein might be varied to accommodate or supplement such additional features. Other aspects, features and advantages will be apparent upon an examination of the attached drawing Figures and appended claims.

What is claimed is:

1. A gas turbine engine comprising:
a plurality of nozzle vanes extending between an inner shroud wall and an outer shroud wall of said engine, each of said vanes including a leading edge;
said vanes each including at least one cooling protrusion extending upstream from a center of said leading edge; and
a cooling system operable to inject cooling air upstream from said vanes.

2. The gas turbine engine of claim 1 wherein said at least one cooling protrusion includes a first and a second cooling protrusion disposed adjacent said inner shroud wall and said outer shroud wall, respectively;
said cooling system being operable to inject cooling air through said inner shroud wall upstream from said first cooling protrusion, and through said outer shroud wall upstream from said second cooling protrusion.

3. The gas turbine engine of claim 2 wherein each of said cooling protrusions includes a nose, said cooling protrusions having a vertical cross section between said shroud walls sloping toward the center of said leading edge in a direction downstream from said nose.

4. The gas turbine engine of claim 3 wherein each of said cooling protrusions includes a flow splitting feature coinciding with said leading edge.

5. The gas turbine engine of claim 4 wherein each said cooling protrusion extends an upstream distance from the center of said leading edge that is greater than a height of each said cooling protrusion between said inner shroud wall and said outer shroud wall.

6. The gas turbine engine of claim 5 wherein each said cooling protrusion extends an upstream distance from the center of said leading edge that is about twice said height.

7. The gas turbine engine of claim 5 wherein said flow splitting feature includes adjacent first and second planar surfaces, said first and second surfaces being symmetrical at least between said nose and the leading edge of said vane.

8. The gas turbine engine of claim 7 wherein:
said first and said second surfaces include respective first and second outboard edges extending downstream from said nose;
said first outboard edge transitioning to a concave side of the associated vane;
said second outboard edge transitioning to a convex side of the associated vane; and
said second outboard edge being longer than said first outboard edge.

9. The gas turbine engine of claim 8 wherein:
said first and second outboard edges have lengths between about six and about eight times the height of the cooling protrusion between said inner and outer shroud walls, said lengths being between about three and about four times the upstream distance between the center of said leading edge and said nose.

10. A gas turbine engine nozzle section comprising:
a first shroud portion having an end wall;
a second shroud portion;
at least one vane connected between said first and second shroud portions, said at least one vane including an airfoil portion and a cooling protrusion disposed adjacent said end wall.

11. The gas turbine engine nozzle section of claim 10 wherein:
said cooling protrusion includes a nose and a flow splitting feature extending between said nose and said airfoil portion;
said cooling protrusion having a cross section sloping between said nose and said airfoil portion.

12. The gas turbine engine nozzle section of claim 10 wherein said cooling protrusion extends along said end wall a first distance, said cooling protrusion extending between said first shroud portion and said second shroud portion a second distance that is less than said first distance.

13. The gas turbine engine nozzle section of claim 12 wherein said flow splitting feature comprises a first planar surface disposed at a first side thereof and a second planar surface disposed at a second side thereof.

14. The gas turbine engine nozzle section of claim 13 comprising:
a vane convex surface and a vane concave surface;
said first surface extends between said nose and said vane concave surface;
said second surface extends between said nose and said vane convex surface, said second surface having a relatively greater surface area than said first surface.

15. The gas turbine engine nozzle section of claim 14 wherein:
said first and second surfaces each extend a distance downstream from;
said nose that is between about three and about four times said first distance.

16. The gas turbine engine nozzle section of claim 13 wherein said nose is disposed an upstream distance from said airfoil portion at a point equal to about 10% a vertical distance between said first shroud and said second shroud.

17. The gas turbine engine nozzle section of claim 16 wherein said cooling protrusion is a first cooling protrusion, said engine further comprising a second cooling protrusion that is substantially a mirror image of the first cooling protrusion and disposed adjacent an end wall of the second shroud.

18. A method of cooling a gas turbine engine comprising the steps of:
supplying cooling air to an engine nozzle upstream of a gas directing vane; and
adjusting the flow of the cooling air with a cooling protrusion extending forward from a leading edge center of the vane.

19. The method of claim 18 wherein the adjusting step comprises
adjusting the flow of cooling air with a cooling protrusion having dimensions calculated as a function of a distance between an inner shroud wall and an outer shroud wall of the engine.

20. The method of claim 19 wherein the step of supplying cooling air comprises:
supplying air from a compressor operably coupled to a shaft of the gas turbine engine; and
supplying less than about 3% of an output of the compressor to cool the end walls.
